(19) United States
(12) Patent Application Publication
(10) Pub. No.: US 2014/0124514 A1
(43) Pub. Date: May 8, 2014

(54) METHOD AND APPARATUS FOR ADDING BUFFERS AND OTHER SUBSTANCES TO MEDICAL CARTRIDGES

(71) Applicant: Onpharma, Inc., Los Gatos, CA (US)

(72) Inventors: Matthew Stepovich, Santa Cruz, CA (US); Michael Falkel, Carmel Highlands, CA (US); Mark Foley, Atlanta, GA (US)

(73) Assignee: Onpharma, Inc., Los Gatos, CA (US)

(21) Appl. No.: 14/068,480

(22) Filed: Oct. 31, 2013

Related U.S. Application Data
(60) Provisional application No. 61/796,370, filed on Nov. 8, 2012.

(51) Int. Cl. A61J 1/20; B65B 3/00

(52) U.S. Cl. CPC A61J 1/2089; B65B 3/003
USPC 220/625; 141/1; 514/626; 514/447; 514/330

(57) ABSTRACT

Anesthetics and other medical solutions are stored in a cartridge including a hollow body having a needle-penetrable septum at one end and a plunger at another end. A protective plug is inserted into the open plunger end of the cartridge and protects the cartridge from contamination per use. A buffer or other material may be injected into the cartridge, causing displacement of the protective plug, allowing the cartridge to then be used in a syringe or other delivery system. The anesthetic may contain at least one solute and have an initial tonicity and an initial pH. A volume of buffer may be injected through the septum into the anesthetic, where the initial solute concentration and initial pH of the anesthetic may be selected to provide a target pH and target tonicity after the buffer is introduced.

### CROSS-REFERENCE

The present invention claims the benefit of provisional application No. 61/796,370 (Attorney Docket No. 36312-716.101), filed on Nov. 8, 2012, the full disclosure of which is incorporated herein by reference.

### BACKGROUND OF THE INVENTION

### Field of the Invention

The present invention relates generally to methods and apparatus for buffering medical solutions, such as anesthetics. More particularly, the present invention relates to methods for buffering and modifying medical solutions which are stored in small cartridges.

Many medical solutions, such as anesthetics, antidotes, and other injectables, are buffered by sodium bicarbonate in order to adjust the pH for optimum effectiveness. In many instances, it is desirable to buffer the medical solution immediately prior to use by adding the sodium bicarbonate or other buffer to a cartridge containing the medical solution just before injection.

One particularly effective approach for combining a buffer or other material with an anesthetic or other medical solution utilizes a needle assembly including both a transfer needle and an exhaust needle. One end of the transfer needle is inserted through a septum into the buffer cartridge and the other end is inserted through a septum into the anesthetic cartridge. The exhaust needle is inserted through the same septum into the anesthetic cartridge and provides a path for removing excess anesthetic as the buffer is introduced into the cartridge, as described for example in commonly owned U.S. Pat. No. 8,162,917 and U.S. Publication No. 2011/0282316, the full disclosures of which are incorporated herein by reference. Such systems, however, result in a small amount of waste of the anesthetic and requires that the wasted anesthetic be managed.

An alternative approach for allowing a buffer or other material to be added into an anesthetic or other cartridge is described in U.S. Pat. No. 5,603,695. There, a rubber plunger 30 in a disposable carpule 22 is recessed within an open end of the carpule. The plunger is able to move toward the open end to accommodate the extra buffer volume being added into the interior of the carpule. While this arrangement accommodates the added buffer volume, the open end of the cartridge is subject to contamination. Moreover, it is often difficult to tell if the plunger has been displaced, and it is therefore not always apparent if buffer or other material has been transferred into the carpule, intentionally or by accident.

For these reasons, it would be desirable to provide additional and alternative apparatus and methods for introducing buffers and other materials into anesthetic and other medical solution cartridges or carpules. It would be particularly desirable if such methods and apparatus could reduce or eliminate the waste of the anesthetic or other medical solution. It would be further desirable if such methods and apparatus would assure the sterility of the anesthetic or other medical solution and would permit a user to easily detect when any material has been added into the cartridge. At least some of these objectives will be met by the inventions described hereinbelow.

Of further interest to the present invention, local anesthetics are typically hypertonic as manufactured and delivered in dental anesthetic cartridges. The anesthetics are also typically acidic, having a pH of from 3 to 5.5. Buffering anesthetics in cartridges toward physiologic pH using medical sodium bicarbonate solutions, as described above, represents one approach to address problems caused by the acidity of the anesthetic cartridges. The addition of sodium bicarbonate, however, increases the hypertonicity of the anesthetic solution.

An optimal level of tonicity would be the same as the tissue and blood of the human body, referred to as “isotonicity.” The tonicity of a solution is often referenced as a measure of the solutes contained in a specified volume of liquid, where the solution's osmolarity is typically expressed as milliosmoles of solute per liter (mOsm/L). Sometimes, the tonicity of the solution is expressed as a measure of solutes contained in the weight of the sample, where the solution's osmolality is typically expressed as a milliosmoles of solute per kilogram (mOsm/kg). Human physiologic osmolarity is approximately 300 milliosmoles per liter (300 mOsm/L).

It would be desirable to provide methods for buffering anesthetics in anesthetic cartridges where the sodium bicarbonate is added to below a hypertonic state, preferably to a state of isotonicity, by formulating the anesthetic in the cartridge prior to buffering as a hypotonic solution, i.e., a solution having an osmolarity of less than 300 mOsm/L.

At least some of these objectives will be met by the inventions described hereinbelow.

### SUMMARY OF THE INVENTION

In a first general aspect of the present invention, a liquid medicament cartridge comprises a hollow body having a first open end and a second open end. Typically, the body will be cylindrical and comprised of glass or other material of the type conventionally used to store liquid medicaments, such as anesthetics and other parenteral solutions. A needle-penetrable septum will be formed over the first open end, and a plunger will be spaced or displaced inwardly from the second open end, typically by a distance and a range from 0.5 mm to 2 mm, typically being about 1 mm for a dental anesthetic cartridge. The hollow body will typically have a length and a range from 50 mm to 75 mm (typically being about 58 mm for a dental anesthetic cartridge), an inner diameter in the range from 5 mm to 10 mm (typically being about 6.85 mm for a dental anesthetic cartridge), and a volume in the range from 1 ml to 5 ml (typically being about 2.1 ml for a dental anesthetic cartridge). In order to maintain sterility of the open second end and an inner cylindrical wall near the open second end, a protective plug will be inserted into the second open end. The protective plug will usually be displaceable as the plunger is advanced by the addition of liquid injected through the septum into an interior of the hollow body. In this way, even a very small displacement of the protective plug can alert the user that material has been added to the cartridge. Additionally, by properly designing the plug, additional displacement can cause the plug to fall from or be easily grasped and removed from the hollow body, thus facilitating subsequent use of the cartridge. Finally, the presence of the plug in the cartridge can prevent use of the cartridge in a syringe system, reducing the risk that the cartridge would be used without first injecting the buffer or other material.

In specific embodiments, the protective plug may have a distal end which engages the plunger and a proximal end which covers the second opening to maintain sterility. Typically, the proximal end will be enlarged or otherwise configured so that it cannot be pushed into the second open end to prevent premature inward displacement of the plunger. Preferably, the proximal end of the plug will be configured so that it is difficult to manually grasp when present over the second open end of the hollow body but easier to grasp when displaced proximally from the second open end.

In a second general aspect of the present invention, a method for buffering anesthetic or other liquid medicament carried in a container comprises injecting or otherwise adding a buffer into an interior of the container to outwardly displace a plunger which in turn will eject a protective plug which covers the open end of the cartridge. The protective plug preferably prevents contamination of the interior walls of the cartridge adjacent to the open end of the cartridge prior to ejection. The protective plug will usually also prevent inward displacement of the plunger prior to removal of the plug, and in preferred examples the plug will be configured so that it cannot be pushed into the container.

In a third general aspect of the present invention, a method for buffering a liquid anesthetic or other medicament having a target tonicity and a target pH comprises providing a volume of the liquid medicament in a sealed container having a septum at one end and a plunger at an opposite end. The medicament within the container will include at least one solute and have an initial tonicity and an initial pH. A volume of buffer is injected through the septum into the medicament. An initial solute concentration and an initial pH of the liquid medicament are selected so that when the volume of buffer is combined with the medicament to achieve a target pH, the resulting buffered medicament will have both the target pH and the target tonicity.

Usually, the target tonicity is less than 500 mOsm/kg, typically being less than 400 mOsm/kg. In particularly preferred embodiments, the target tonicity will be substantially isotonic.

Anesthetics will usually have an original pH below 6 and the volume of buffer will be selected to raise the pH of the buffered anesthetic to a target pH of at least 7, preferably to at least 7.3. In particularly preferred embodiments, the target tonicity will be 7.45.

In specific examples, the solute accompanying the anesthetic or other medical solution may comprise sodium chloride. In other examples, the medical solution may further include a vasoconstrictor, such as epinephrine or levonordefrine. The buffer may comprise sodium bicarbonate, and the cartridge will typically be prepared at a central manufacturing facility, where the cartridges are then distributed to a plurality of local users, where the users typically add the buffer before delivering the anesthetic injection. For example, the users may be dentists or other practitioners who combine the buffer and anesthetic immediately prior to a procedure in order to produce buffered anesthetic for use in the procedure. In such cases, it will be desirable to introduce the buffer immediately prior to use, typically within two minutes of use.

The local anesthetics may be any one of a variety of anesthetics typically used in dentistry and elsewhere, such as amide local anesthetics and amine local anesthetics, with specific examples being lidocaine, articaine, mepivacaine, and the like. The internal volumes of these cartridges may be in the range from 1.45 ml to 2.3 ml, the anesthetic volume may be in the range from 1.15 ml to 2.2 ml, and the buffer volume to be added may be in the range from 0.05 ml to 0.5 ml.

In a first specific aspect of the invention, as an alternative to systems that include an exhaust needle and/or reservoir to prevent the displacement of a plunger when a pH buffer is added to the cartridge containing the anesthetic or other parenteral solution, an anesthetic cartridge may instead be filled to a preselected volume less than its maximum, where the filled volume allows an additional volume of pH buffer to be added. While such additional volume will cause displacement of the plunger, such displacement will not result in the plunger being displaced to a point where the function of the cartridge is compromised.

In a second specific aspect of the invention, such cartridges may also employ methods of maintaining the sterility of portions of the glass cartridge that would come into contact with the solution as the plunger is displaced outward.

In a third specific aspect of the invention, the cartridge would include a mechanism that prevents the non-buffered cartridge from being loaded into the syringe until the pH buffering process has been completed, in order to prevent the injection of the contents of an unbuffered cartridge.

In a fourth specific aspect of the present invention, syringe can be loaded but the plunger cannot be displaced by the syringe.

In a fifth specific aspect of the invention, an inventory of containers of local anesthetic solution having a lesser degree of osmotic pressure, or lower concentration of solutes, than the standard 2% local anesthetic solution currently available in the marketplace are provided.

In a sixth aspect of the invention, the concentration of epinephrine in the pre-buffered cartridge would be adjusted so that after the addition of the pH buffer, the concentration of epinephrine would be at the standard for such anesthetics, for instance 1:200,000, 1:100,000, or 1:50,000.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a prior art medical solution cartridge having buffer or other material transferred by a transfer needle.

FIG. 2 illustrates a plug according to the present invention suitable for insertion into an open plunger end of a medical solution cartridge in order to maintain the sterility of that end.

FIG. 3 illustrates the plug of FIG. 2 inserted into a medical solution cartridge of the type illustrated in FIG. 1.

FIG. 4 shows the effect of material transfer into the cartridge shown in FIG. 3 to displace the plug from the plunger end of the cartridge.

### DETAILED DESCRIPTION OF THE INVENTION

By manufacturing a hypotonic local anesthetic solution that is intended to be buffered prior to use, it is possible to create an anesthetic that can be buffered to an optimal pH using a known concentration of sodium bicarbonate solution, where the buffered solution is isotonic (having a physiologic osmolarity) after the buffering process has been completed.

In this process, a hypotonic local anesthetic solution would be manufactured to a known and precise osmolarity. This osmolarity would be hypotonic, which means that it would have an osmolarity below that of human blood and tissues, which is approximately 300 mOsm/L (300 milliosmoles per liter). The local anesthetic would be formulated to a sufficiently hypotonic level that with the addition of a desired amount of a known concentration of sodium bicarbonate solution, for instance 0.35mL of 8.4% sodium bicarbonate, the resulting mixed solutions would be isotonic (300 mOsm/L). As has been described in filings incorporated herein by reference, the mechanism for adding the buffering solution to the anesthetic cartridge may include transferring buffering solution into the cartridge using a transfer needle, while an exhaust needle allows an equal amount of anesthetic solution to leave the cartridge.

In another embodiment that would not require an exhaust needle or other mechanism to prevent the plunger from moving distally past the end of the glass cartridge, the anesthetic cartridge would be manufactured having the plunger at a predetermine distance proximally toward the septum, such that with the addition of an intended amount of buffering solution, the plunger would move distally from the septum, but not past the open end of the glass cartridge. By way of example and not limitation, a plunger that is placed 10 mm proximal to the septum from the open end of a glass cartridge will be displaced approximately 10 mm toward the open end of the cartridge with the addition of 0.35 mL of solution. For some 2% local anesthetics, the osmolarity of the solution would be such that, when buffered using 0.35 mL of 8.4% sodium bicarbonate, the combined solutions would be approximately isotonic, which is to say that their post-combination osmolarity would be approximately 300 mOsm/kg. Likewise by way of example and not limitation, where local anesthetic having a higher concentration is used, a plunger could be placed 4 mm proximal to the septum from the open end of a glass cartridge will be displaced approximately 4 mm toward the open end of the cartridge with the addition of 0.15 mL of solution.

In these ways, the glass cartridge, or other container, would be partially filled to accept the addition of a buffering solution, such as sodium bicarbonate, without over filling the glass cartridge, or other container, which may result in the plunger being disengaged from the glass cartridge.

One embodiment of the present invention also includes a cap, or other barrier, over the plunger end of the glass cartridge to keep sterile the area of the glass cartridge between the outward end of the plunger and the end of the glass cartridge. Without a cap, or other barrier, this area of the glass cartridge would be open to the environment and consequently may contaminate the local anesthetic solution after it is buffered with the buffering solution. The barrier may be made of a substance that permeable to gas but not biologics, for instance Tyvex, and it may also be easily penetrable by the syringe's harpoon, so that the cartridge can function in the normal way intended for local anesthetic cartridges in aspirating dental syringes.

In a partially filled cartridge as described, or a filled cartridge with an exhaust needle, also as described, a hypotonic local anesthetic solution could be formulated at slightly above the standard, for instance as a 2.4% solution, so that after it is combined with 0.35 mL of sodium bicarbonate buffering solution, the resulting concentration of local anesthetic solution would be close to or at the standard 2%. Similarly a formula that included a greater concentration of epinephrine in the original solution would make it possible that after the buffering solution is added the epinephrine would be at its traditional concentration, for instance 1:200,000, 1:100,000, or 1:50,000.

A still further aspect to the invention is to create a mechanism by which the hypotonic cartridge cannot be used with a standard dental anesthetic syringe until the buffering system has completed the transfer of buffering solution into the anesthetic cartridge. By way of example but not limitation, the crimp cap on the hypotonic local anesthetic cartridge can be fitted with a plastic clip that is too large to allow the anesthetic cartridge to be used in a traditional dental syringe or with the other standard dental anesthetic delivery devices (Comfort Control, The Wand, etc.). The buffering system could include a feature that removes the clip as part of the buffering process, for instance if the cartridge connector included a flange that would disconnect the clip as the anesthetic cartridge was being inserted into the connector. In this way, if using a hypotonic solution was considered undesirable and a feature to prevent accidentally using a cartridge that had yet to be cycled through the system, for instance the Onpharmat mixing pen and Cartridge Connector, it would be more difficult to accidentally use an unbuffered hypotonic anesthetic cartridge.

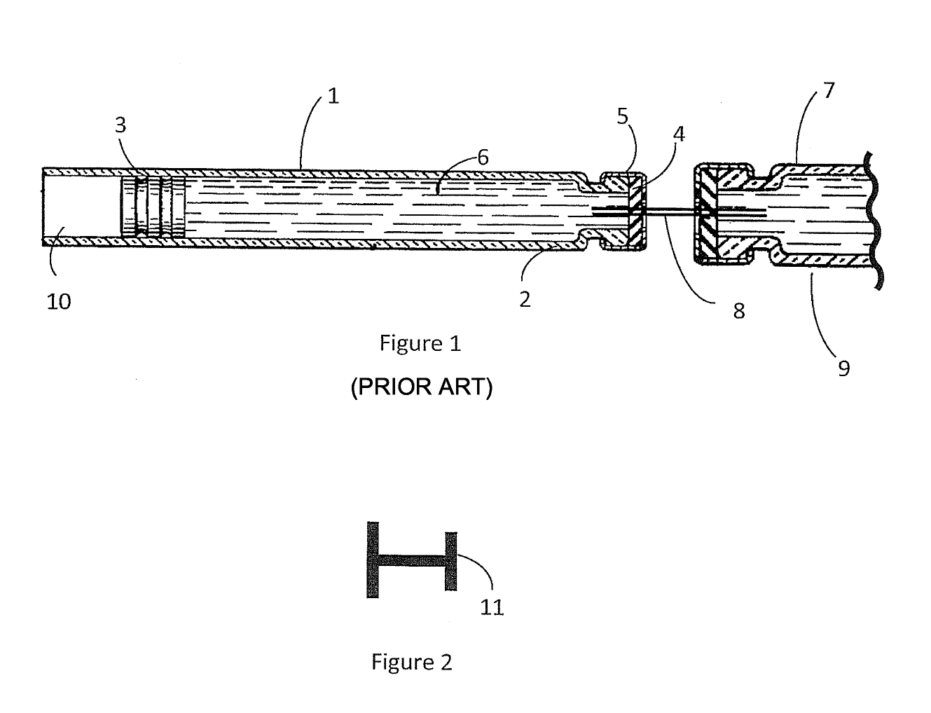

In still another embodiment of this invention, where there is no exhaust needle and the plunger is aligned at a distance from the open end of the glass cartridge in order to allow the plunger to move distally from the septum end of the cartridge as the buffering solution is added, a plug would be inserted into this “gap,” and the plug would be configured such that the syringe's piston or other device that would normally push against the plunger to dispense fluid would be prevented from moving forward by the plug. After the plunger has been moved distally by the addition of the buffering solution, this plug could be easily grasped and removed. This mechanism would be applicable outside the context of buffering anesthetic, to any context where a cartridge of one medical solution is intended to be used only after it has been compounded with another medical solution that is added to the first medical solution's cartridge. An example of such a mechanism is shown in FIGS. 1-4.

Numbered features not described below are described in the above-referenced patent applications.

FIG. 1 shows a cartridge 1 that has been partially filled in anticipation of delivery of solution from container 7, through transfer tube 8. It is expected that as fluid transfers from container 7 into cartridge 1, plunger 3 will be driven distally from septum 4 (to the left in this drawing), toward the open end of the glass housing 2, and it will begin to occupy space 10, which has been left for this purpose.

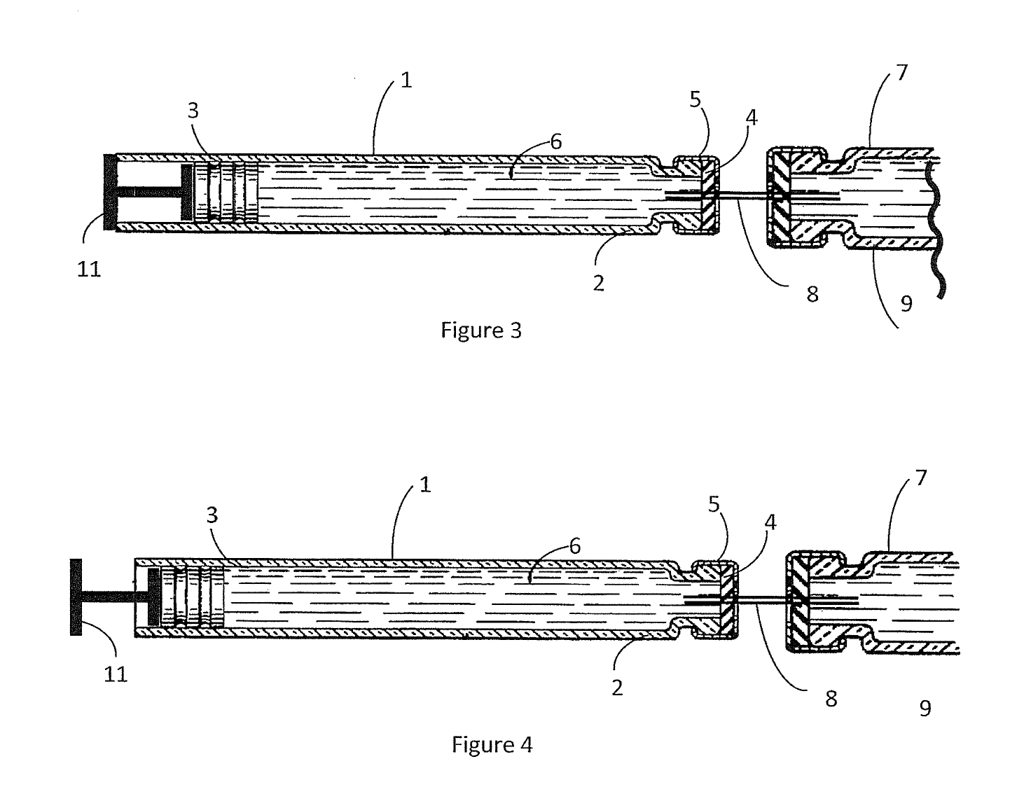

FIG. 2 shows plug 11, which is intended to be inserted into space 10, as shown in FIG. 3, which is the configuration of the cartridge before buffering (or for other medical compounding applications, prior to admixing a second medical solution with the medical solution in the target cartridge). In the configuration shown in FIG. 3, if a practitioner were to load this cartridge into a dental syringe or any other dispensing device for the cartridge, the piston on the cartridge, which normally would press the plunger 3 proximally (rightward) toward septum 4, would instead strike plug 11. The piston would be prevented from moving any further proximally to septum 4, or from moving plunger 3, thus fluid could not be dispensed from the cartridge in FIG. 3.

FIG. 4 shows cartridge 1 in the configuration representative of cartridge 1 after the buffering solution (or other medical solution) has been dispensed into cartridge 1 from container 9, which has moved plunger 3 distally (leftward) from septum 4. This has displaced plug 11, which can be grasped easily by the practitioner and removed from open space 10 in cartridge 1. Once plug 11 has been removed, cartridge 1 can be loaded into a dispensing device such as a dental syringe, which can function as normal to dispense the buffered or otherwise compounded medical solution, in the normal fashion.

The invention disclosed herein limits the potential side effects of injecting hypertonic local anesthetics, while allowing the pH to be adjusted to the level deemed optimal for improving the anesthetic's performance.

While the above is a description of one or more preferred embodiments of the invention, various alternatives, modifications, and equivalents may be used. Therefore, the above description should not be taken as limiting the scope of the invention which is disclosed.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A liquid medicament cartridge comprising:
a hollow body having a first open end and a second open end;
a needle-penetrable septum over the first open end;
a plunger spaced inwardly from the second open end; and
a protective plug inserted into the second open end, said protective plug being displaceable as additional liquid is injected through the septum into the hollow body to cause the plunger to move toward the plug.

2. A medicament cartridge as in claim 1, wherein the hollow body comprises a glass tube.

3. A medicament cartridge as in claim 1, wherein the protective plug has a distal end which engages the plunger and a proximal end which covers the second opening to maintain sterility.

4. A medicament cartridge as in claim 3, wherein the proximal end of the plug is configured so that it cannot be pushed into the second open end of the hollow body to prevent premature inward displacement of the plunger.

5. A medicament cartridge as in claim 3, wherein the proximal end of the plug is configured so that it is difficult to manually grasp when present over the second open end of the hollow body and easier to grasp when displaced proximally from the second open end.

6. A medicament cartridge as in claim 1, further comprising a liquid medicament present in an interior of the hollow body.

7. A medicament cartridge as in claim 6, wherein the liquid medicament comprises an anesthetic solution.

8. A method for buffering a medicament solution carried in a container, said method comprising:
injecting a buffer into the container to outwardly displace a plunger which in turn ejects a protective plug which covers an open end of the container.

9. A method as in claim 8, wherein the protective plug prevents contamination of the cartridge prior to ejection.

10. A method as in claim 8, wherein the protective plug prevents inward displacement of the plunger prior to ejection.

11. A method as in claim 8, wherein the plunger is configured so that it cannot be pushed into the container.

12. A method as in claim 8, wherein the liquid medicament comprises an anesthetic solution.

13. A method for buffering a liquid medicament having a target tonicity and pH, said method comprising:
providing a volume of the liquid anesthetic in a sealed container having a septum at one end and a plunger at an opposite end, wherein the medicament contains at least one solute and has an initial tonicity and an initial pH; and
injecting a volume of buffer through the septum into the medicament;
wherein the liquid medicament has an initial solute concentration and an initial pH selected so that the buffered medicament will have both the target pH and the target tonicity.

14. A method as in claim 13, wherein the target tonicity is less than 500 mOsm/kg.

15. A method as in claim 13, wherein the target tonicity is less than 400 mOsm/kg.

16. A method as in claim 13, wherein the target tonicity is substantially isotonic.

17. A method as in claim 13, wherein the liquid medicament comprises an anesthetic solution.

18. A method as in claim 13, wherein the anesthetic originally has a pH below 6.0 and the volume of buffer raises the pH of the buffered anesthetic to a target pH of at least 7.0.

19. A method as in claim 18, wherein the volume of buffer increases the pH to a target pH of at least 7.3.

20. A method as in claim 19, wherein the target pH is at least 7.45.

21. A method as in claim 13, wherein the at least one solute comprises sodium choride.

22. A method as in claim 13, wherein the anesthetic further comprises a vasoconstrictor.

23. A method as in claim 22, wherein the vasoconstrictor comprises levonordefrine.

24. A method as in claim 22, wherein the vasoconstrictor comprises epinephrine.

25. A method as in claim 13, wherein the buffer comprises sodium bicarbonate solution.

26. A method as in claim 13, wherein the cartridge is prepared at a central manufacturing facility and the cartridges are distributed to a plurality of local users, wherein the users add the buffer to the cartridges.

27. A method as in claim 26, wherein the users inject the buffer prior to a procedure, in order to produce buffered medicament for use in the procedure.

28. A method as in claim 27, wherein at least a portion of the buffered medicament is injected into a patient within two minutes of introducing the buffer.

29. A method as in claim 13, wherein the local anesthetic is an amide local anesthetic.

30. A method as in claim 13, wherein the local anesthetic is an amine local anesthetic.

31. A method as in claim 13, wherein the local anesthetic is lidocaine.

32. A method as in claim 13, wherein the local anesthetic is articaine.

33. A method as in claim 13, wherein the local anesthetic is mepivacaine.

34. A method as in claim 13, wherein an internal volume of the anesthetic cartridge is in the range from 1.45 ml to 2.3 ml, the anesthetic volume is in the range from 1.15 ml to 2.2 ml, and the buffer volume is in the range from 0.05 ml to 0.5 ml.
